(19) United States
(12) Patent Application Publication
(10) Pub. No.: US 2024/0310043 A1
(43) Pub. Date: Sep. 19, 2024

(54) ELECTRONIC PRESSURE REGULATOR WITH ENHANCED TURNDOWN RATIO

(71) Applicant: ASCO, L.P., Florham Park, NJ (US)

(72) Inventors: Sachinkumar Hasmukhbhai Patel, Ahemdabad (IN); Patrick Miller, Elmwood Park, NJ (US)

(21) Appl. No.: 18/606,773

(22) Filed: Mar. 15, 2024

(30) Foreign Application Priority Data
Mar. 15, 2023 (IN) 202321017450

(51) Int. Cl. F23N 1/00; F23N 5/18; F23N 5/26

(52) U.S. Cl. CPC F23N 1/005; F23N 5/187; F23N 5/265; F23N 2223/36; F23N 2225/04; F23N 2237/10; F23N 2241/04

(57) ABSTRACT

A fuel regulator, such for use in a commercial boiler, can include a control valve plumbed between a source line and a feed line. The feed line can be coupled to a burner configured to burn fuel supplied thereto at a range of pressures and the source line can be coupled to a source of fuel configured to supply the fuel at a pressure higher than the range of pressures. One or more sensors can be configured to detect an operating level of the burner. One or more actuators can be configured to control the valve according to the sensor and thereby control a flame from the burner.

### CROSS-REFERENCE TO RELATED APPLICATIONS

This application claims the benefit of Indian Provisional Patent Application No. 20/232,1017450 filed Mar. 15, 2023, the entirety of which is incorporated herein by reference.

### BACKGROUND OF THE INVENTION

Field of the Invention The present disclosure relates generally to pressure regulators and more specifically relates to electronic pressure regulators, such as those for use in commercial boilers.

### DESCRIPTION OF THE RELATED ART

Electronic pressure regulators are often used to control the fuel feed into commercial boilers, for example. Where such a boiler is fired at one level, or off, its pressure regulator can be optimized for providing fuel at the necessary pressure and flow rate for that one operational level.

However, where a boiler, or other application, needs to operate a more than one level, precise control at the lower operating levels is sometimes sacrificed. This leads to less control, wasted fuel, and higher emissions.

The term turndown ratio is generally understood to mean the ratio of the highest flow rate to the lowest flow rate at steady state operation and keeping within acceptable operational parameters. A high turndown ratio is desirable for achieving a greater level of efficiency. However, current pressure regulators that are capable of high flow rates, and thus high levels of operation, lack precise control at lower flow rates, and lower levels of operation.

### SUMMARY OF THE INVENTION

Applicants have created new and useful devices, systems and methods for electronic pressure regulator with an enhanced turndown ratio.

In at least one embodiment, a regulator can include a control valve plumbed between a source line and a feed line, a sensor configured to detect an operational parameter of the consumer, and an actuator configured to control the valve according to the sensor and thereby control the consumer. In at least one embodiment, the feed line can be configured to supply material to a consumer of the material. In at least one embodiment, the source line can be coupled to a source of the material.

In at least one embodiment, the actuator can control the valve in a low output mode when the sensor detects the operational parameter below a threshold, and a high output mode when the sensor detects the operational parameter above the threshold. In at least one embodiment, the actuator can run a control loop with one set of gain settings, such as from a lookup table or database, when the sensor detects the operational parameter below a threshold, and another set of gain settings, such as from the lookup table or database, when the sensor detects the operational parameter above the threshold. In at least one embodiment, one set of gain settings can be different from another set of gain settings. In at least one embodiment, the actuator can run a proportional integral (PI) control loop with a different gain setting for the proportional and integral components, such as from a lookup table or database based on one or more process inputs (including but not limited to valve position, pressure, flow rate, pipe size, etc.), when the sensor detects the operational parameter above or below a threshold. In at least one embodiment, two or more gain settings in a lookup table or database can be different from each other.

In at least one embodiment, the sensor can be a switch, such as a pressure, flow, or temperature switch. In at least one embodiment, the sensor can be an analog or digital pressure, flow, or temperature sensor.

In at least one embodiment, a fuel regulator, such for use in a commercial boiler, can include a control valve plumbed between a source line and a feed line, a sensor configured to detect an operating level of from a burner, and an actuator configured to control the valve according to the sensor and thereby control the burner. In at least one embodiment, the feed line can be coupled to a burner configured to burn fuel supplied thereto at a range of pressures and/or flow rates. In at least one embodiment, the source line can be coupled to a source of fuel configured to supply the fuel at a pressure and/or flow rate higher than the range.

In at least one embodiment, the actuator can control the valve in a low output mode when the sensor detects the operational parameter below a threshold, and a high output mode when the sensor detects the operational parameter above the threshold. In at least one embodiment, the actuator can run a control loop with one set of gain settings, such as from a lookup table or database, when the sensor detects the operational parameter below a threshold, and another set of gain settings, such as from the lookup table or database, when the sensor detects the operational parameter above the threshold. In at least one embodiment, one set of gain settings can be different from another set of gain settings. In at least one embodiment, the actuator can run a proportional integral (PI) control loop with a different gain setting for the proportional and integral components, such as from a lookup table or database based on one or more process inputs (including but not limited to valve position, pressure, flow rate, pipe size, etc.), when the sensor detects the operational parameter above or below a threshold. In at least one embodiment, two or more gain settings in a lookup table or database can be different from each other.

In at least one embodiment, the sensor can be a switch, such as a pressure, flow, or temperature switch. In at least one embodiment, the sensor can be an analog or digital pressure, flow, or temperature sensor.

### BRIEF DESCRIPTION OF DRAWINGS

FIG. 1 is a simplified block diagram of one of many embodiments of a system utilizing an electronic regulator according to the disclosure.

FIG. 2 is a perspective view of one of many embodiments of an electronic regulator according to the disclosure.

### DETAILED DESCRIPTION OF THE INVENTION

The figures described above and the written description of specific structures and functions below are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms.

The use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the figures and are not intended to limit the scope of the inventions or the appended claims. The terms “including” and “such as” are illustrative and not limitative. The terms “couple,” “coupled,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and can further include without limitation integrally forming one functional member with another in a unity fashion. The coupling can occur in any direction, including rotationally. Further, all parts and components of the disclosure that are capable of being physically embodied inherently include imaginary and real characteristics regardless of whether such characteristics are expressly described herein, including but not limited to characteristics such as axes, ends, inner and outer surfaces, interior spaces, tops, bottoms, sides, boundaries, dimensions (e.g., height, length, width, thickness), mass, weight, volume and density, among others.

Any process flowcharts discussed herein illustrate the operation of possible implementations of systems, methods, and computer program products according to various embodiments of the present disclosure. In this regard, each block in a flowchart may represent a module, segment, or portion of code, which can comprise one or more executable instructions for implementing the specified logical function(s). It should also be noted that, in some implementations, the function(s) noted in the block(s) might occur out of the order depicted in the figures. For example, blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Applicants have created new and useful devices, systems and methods for providing an enhanced turndown ratio in an electronic pressure regulator. In at least one embodiment, a regulator according to the disclosure can have a higher turndown ratio for achieving a greater level of efficiency. In at least one embodiment, a regulator according to the disclosure can be capable of high flow rates, and thus high levels of operation, as well as precise control at lower flow rates, and lower levels of operation.

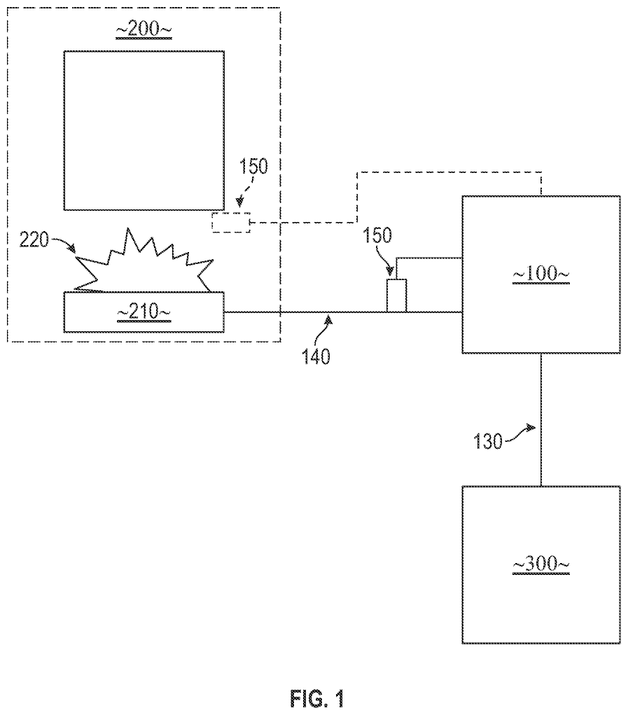

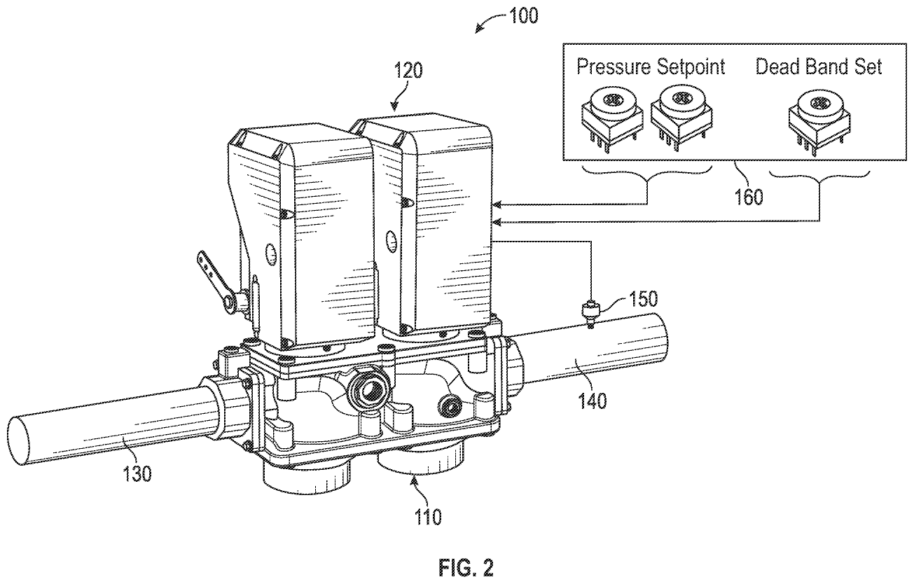

FIG. 1 is a simplified block diagram of one of many embodiments of a system utilizing an electronic regulator according to the disclosure. FIG. 2 is a perspective view of one of many embodiments of an electronic regulator according to the disclosure. FIGS. 1-2 are described in conjunction with one another.

In at least one embodiment, a regulator 100, such as for regulating fuel flow in a commercial boiler 200, can include a control valve 110 plumbed between a source line 130 and a feed line 140, a sensor 150 configured to detect an operating level, or parameter, of a burner 210, and an actuator 120 configured to control the valve 110 according to the sensor 150 and thereby control a flame 220 from the burner 210. In at least one embodiment, a regulator 100, such for use regulate fuel flow in a commercial boiler 200, can include a control valve 110 plumbed between a source line 130 and a feed line 140, a sensor 150 configured to detect a pressure in the feed line 140 to a burner 210, and an actuator 120 configured to control the valve 110 according to the sensor 150 and thereby control a flame 220 from the burner 210. In at least one embodiment, a regulator 100, such for use regulate fuel flow in a commercial boiler 200, can include a control valve 110 plumbed between a source line 130 and a feed line 140, a sensor 150 configured to detect a flow rate in the feed line 140 to a burner 210, and an actuator 120 configured to control the valve 110 according to the sensor 150 and thereby control a flame 220 from the burner 210. In at least one embodiment, a regulator 100, such for use regulate fuel flow in a commercial boiler 200, can include a control valve 110 plumbed between a source line 130 and a feed line 140, a sensor 150 configured to detect a flame level of a flame 220 from a burner 210, and an actuator 120 configured to control the valve 110 according to the sensor 150 and thereby control the flame 220 from the burner 210.

While one contemplated application for the present inventions is fuel regulation for a commercial boiler 200, there are many other potential applications for the features described herein, such as regulation of virtually any material flow. For example, the regulator 100 can be used to control the flow rate and/or pressure of pneumatic process control media. As such, the regulator 100 can be used to control a variety of operational parameters through the control of the flow rate and/or pressure of a variety of materials. In at least one embodiment, the valve 110 can be an ASCO series 158 valve. In at least one embodiment, the actuator 120 can be an ASCO series 159 actuator.

In at least one embodiment, the feed line 140 can be coupled to the burner 210, or other consumer of the material/fuel, and be configured to burn fuel supplied thereto at a range of pressures and/or flow rates. In at least one embodiment, the source line 130 can be coupled to a source 300 of fuel configured to supply the fuel at a pressure and/or flow rate higher than the range. For example, the source 300 may be a pressure regulator upstream of the regulator described herein, with that upstream regulator 300 being able to supply the fuel, or other material, at a slightly higher flow rate and/or pressure than needed for the burner 210, or other consumer.

In at least one embodiment, the actuator 120 can control the valve 110 in a low output mode when the sensor 150 detects an operating level, or parameter, below a threshold and a high output mode when the sensor 150 detects the operating level, or parameter, above the threshold. In at least one embodiment, the actuator 120 can control the valve 110 in a low output mode when the sensor 150 detects a pressure in the feed line 140 below a threshold and a high output mode when the sensor 150 detects the pressure in the feed line 140 above the threshold. In at least one embodiment, the actuator 120 can control the valve 110 in a low output mode when the sensor 150 detects a flow rate in the feed line 140 below a threshold and a high output mode when the sensor 150 detects the flow rate in the feed line 140 above the threshold. In at least one embodiment, the actuator 120 can control the valve 110 in a low output mode when the sensor 150 detects a flame level below a threshold and a high output mode when the sensor 150 detects the flame level above the threshold.

In at least one embodiment, the regulator 100 can be used to provide more precise control than the upstream regulator or other source 300. For example, in at least one embodiment, the regulator 100 can maintain a 1% deadband in both high output mode, such as when the flame level is above the threshold, and low output mode, such as when the flame level is below the threshold, and is thereby able to consistently maintain combustion at very low flow rates with minimal emissions.

In at least one embodiment, the actuator 120 can run a control loop with one gain setting, such as a first or other gain setting, when the sensor 150 detects an operating level, or parameter, below a threshold, and another gain setting, such as a second or other gain setting, when the sensor 150 detects the operating level, or parameter, above the threshold. In at least one embodiment, the actuator 120 can run a control loop with one gain setting, such as a first or other gain setting, when the sensor 150 detects a pressure in the feed line 140 below a threshold, and another gain setting, such as a second or other gain setting when the sensor 150 detects the pressure in the feed line 140 above the threshold. In at least one embodiment, the actuator 120 can run a control loop with one gain setting, such as a first or other gain setting, when the sensor 150 detects a flow rate in the feed line 140 below a threshold, and another gain setting, such as a second or other gain setting, when the sensor 150 detects the flow rate in the feed line 140 above the threshold. In at least one embodiment, the actuator 120 can run a control loop with one gain setting, such as a first or other gain setting, when the sensor 150 detects a flame level below a threshold, and another gain setting, such as a second or other gain setting when the sensor 150 detects the flame level above the threshold. In at least one embodiment, the first gain setting can be different from the second gain setting. In at least one embodiment, the first gain setting can be higher than the second gain setting. In at least one embodiment, the first gain setting can be lower than the second gain setting.

As used herein, the terms “first,” “second,” “third,” and so on, are for ease of reference only and are not limitative unless expressly indicated otherwise. For example, a “first” gain setting can, but need not, be or occur first in time, and may in fact be or occur subsequently to one or more other gain settings, whether described as a “second” gain setting, a “third” gain setting, or otherwise. Any gain setting can be or occur at any time and in any order, as required or desired in accordance with a physical implementation of the disclosure. Furthermore, one or more gain settings can be or include a plurality of gain settings, such as a set of gain settings. In at least one embodiment, one or more gain settings can be or include a gain setting or a set of gain settings obtained from a lookup table or database stored within or otherwise accessible by the actuator 120 or a component thereof, such as a controller. For example, in at least one embodiment, the lookup table or database can include data based on or reflecting one or more process inputs, such as valve position, pressure, flow rate, flow area, pipe size, any other process input according to an implementation of the disclosure, or any combination thereof.

In at least one embodiment, the actuator 120 can run a proportional integral (PI) control loop with a first gain setting for the proportional component and a second gain setting for the integral component when the sensor 150 detects an operating level, or parameter, below a threshold, and a third gain setting for the proportional component and a fourth gain setting for the integral component when the sensor 150 detects the operating level, or parameter, above the threshold. In at least one embodiment, the actuator 120 can run a proportional integral (PI) control loop with a first gain setting for the proportional component and a second gain setting for the integral component when the sensor 150 detects a pressure in the feed line 140 below a threshold, and a third gain setting for the proportional component and a fourth gain setting for the integral component when the sensor 150 detects the pressure in the feed line 140 above the threshold. In at least one embodiment, the actuator 120 can run a proportional integral (PI) control loop with a first gain setting for the proportional component and a second gain setting for the integral component when the sensor 150 detects a flow rate in the feed line 140 below a threshold, and a third gain setting for the proportional component and a fourth gain setting for the integral component when the sensor 150 detects the flow rate in the feed line 140 above the threshold. In at least one embodiment, the actuator 120 can run a proportional integral (PI) control loop with a first gain setting for the proportional component and a second gain setting for the integral component when the sensor 150 detects a flame level below a threshold, and a third gain setting for the proportional component and a fourth gain setting for the integral component when the sensor 150 detects the flame level above the threshold. In at least one embodiment, the first gain setting can be different from the third gain setting and/or the second gain setting can be different from the fourth gain setting. In at least one embodiment, the first gain setting can be higher or lower than the third gain setting. In at least one embodiment, the second gain setting can be higher or lower than the fourth gain setting. In at least one embodiment, the first gain setting can be the same as the third gain setting, with the second gain setting being different from the fourth gain setting. In at least one embodiment, the first gain setting can be different from the third gain setting, with the second gain setting being the same as the fourth gain setting.

In at least one embodiment, the actuator 120 can run a proportional integral (PI) control loop with a different gain setting for the proportional and integral components, such as from a lookup table or database based on one or more process inputs, when the sensor 150 detects an operating level, or parameter, above or below a threshold. In at least one embodiment, the actuator 120 can run a proportional integral (PI) control loop with a different gain setting for the proportional and integral components, such as from a lookup table or database based on one or more process inputs, when the sensor 150 detects a pressure in the feed line 140 above or below a threshold. In at least one embodiment, the actuator 120 can run a proportional integral (PI) control loop with a different gain setting for the proportional and integral components, such as from a lookup table or database based on one or more process inputs, when the sensor 150 detects a flow rate in the feed line 140 above or below a threshold. In at least one embodiment, the actuator 120 can run a proportional integral (PI) control loop with a different gain setting for the proportional and integral components, such as from a lookup table or database based on one or more process inputs, when the sensor 150 detects a flame level above or below a threshold. In at least one embodiment, gain settings for the proportional and integral components in a lookup table or database can be different from one another. In at least one embodiment, one gain setting can be higher or lower than one or more other gain settings. In at least one embodiment, two or more gain settings can be different from one another. In at least one embodiment, two or more gain settings can be the same.

In at least one embodiment, the actuator 120 can run a proportional integral derivative (PID) control loop with one gain setting, such as a first gain setting, when the sensor 150 detects an operational parameter below a threshold, and another gain setting, such as a second gain setting, when the sensor 150 detects the operational parameter above the threshold. In at least one embodiment, one or more gain settings can be or include a set of gain settings, such as from a lookup table or database based on one or more process inputs. In at least one embodiment, the actuator 120 can run any combination of a proportional integral derivative (PID) control loop, such as purely proportional, with one gain setting, such as a first gain setting, when the sensor 150 detects the operational parameter below a threshold, and another gain setting, such as a second gain setting, when the sensor 150 detects the operational parameter above the threshold. In at least one embodiment, one or more gain settings can be or include a set of gain settings, such as from a lookup table or database based on one or more process inputs. In at least one embodiment, any one of more of the gain settings can be different based on the detected operational parameter, such as pressure, flow, temperature, or flame level.

In at least one embodiment, the regulator 100 can take a pressure sensor input as feedback for a PI control loop. In at least one embodiment, the actuator 120 can maintain an outlet pressure, such as the pressure in feed line 140, at a pressure setpoint through different flow rates of different operating levels of the burner 210. In at least one embodiment, the pressure setpoint can be set by one or more inputs 160, such as rotary switches. By maintaining the outlet pressure the pressure setpoint through the different flow rates, the regulator 100 can controls the flame 200 to efficiently burn the fuel. By controlling the flame 200 to efficiently burn the fuel, the regulator 100 can minimize emissions.

In at least one embodiment, the valve 110 can have a different orifice than what might normally be used. For example, because the actuator 120 can use different control parameters based on the operational level of the burner 210, or other consumer, the valve 100 can use a smaller orifice than might normally be used. In at least one embodiment, the actuator 120 utilizes lower gain settings when a lower operational mode is desired, thereby achieving finer control at lower flow rates and/or pressures; and higher gain settings when a higher operational mode is desired, thereby achieving the higher flow rates and/or pressures. In at least one embodiment, one or more gain settings can be or include one or more gain settings from a lookup table or database based on one or more process inputs. In at least one embodiment, the actuator 120 utilizes higher gain settings when a lower operational mode is desired, thereby achieving more precise control at lower flow rates and/or pressures; and lower gain settings when a higher operational mode is desired, thereby achieving the higher flow rates and/or pressures.

In at least one embodiment, the sensor 150 can be a switch, such as a pressure, flow, or temperature switch. In at least one embodiment, the sensor 150 can be an analog or digital pressure, flow, or temperature sensor. In at least one embodiment, the sensor 150 can detect a range of pressures, flows, or temperatures. In at least one embodiment, the sensor 150 can detect some other operational parameter and/or desired mode of operation.

In at least one embodiment, a regulator can include a control valve plumbed between a source line and a feed line, a sensor configured to detect an operational parameter of the consumer, and an actuator configured to control the valve according to the sensor and thereby control the consumer. In at least one embodiment, the feed line can be configured to supply material to a consumer of the material. In at least one embodiment, the source line can be coupled to a source of the material.

In at least one embodiment, the actuator can control the valve in a low output mode when the sensor detects the operational parameter below a threshold and a high output mode when the sensor detects the operational parameter above the threshold. In at least one embodiment, the actuator can run a control loop with a first gain setting when the sensor detects the operational parameter below a threshold and a second gain setting when the sensor detects the operational parameter above the threshold. In at least one embodiment, the first gain setting can be different from the second gain setting. In at least one embodiment, the actuator can run a proportional integral control loop with a first gain setting for the proportional component and a second gain setting for the integral component when the sensor detects the operational parameter below a threshold; and a third gain setting for the proportional component and a fourth gain setting for the integral component when the sensor detects the operational parameter above the threshold. In at least one embodiment, the first gain setting an be different from the third gain setting and the second gain setting can be different from the fourth gain setting.

In at least one embodiment, the actuator can control the valve in a low output mode when the sensor detects the operational parameter below a threshold, and a high output mode when the sensor detects the operational parameter above the threshold. In at least one embodiment, the actuator can run a control loop with one set of gain settings, such as from a lookup table or database, when the sensor detects the operational parameter below a threshold, and another set of gain settings, such as from the lookup table or database, when the sensor detects the operational parameter above the threshold. In at least one embodiment, one set of gain settings can be different from another set of gain settings. In at least one embodiment, the actuator can run a proportional integral (PI) control loop with a different gain setting for the proportional and integral components, such as from a lookup table or database based on one or more process inputs (including but not limited to valve position, pressure, flow rate, pipe size, etc.), when the sensor detects the operational parameter above or below a threshold. In at least one embodiment, two or more gain settings in a lookup table or database can be different from each other.

In at least one embodiment, the sensor can be a switch, such as a pressure, flow, or temperature switch. In at least one embodiment, the sensor can be an analog or digital pressure, flow, or temperature sensor.

In at least one embodiment, a fuel regulator, such for use in a commercial boiler, can include a control valve plumbed between a source line and a feed line, a sensor configured to detect an operating level of a burner, and an actuator configured to control the valve according to the sensor and thereby control the burner. In at least one embodiment, the feed line can be coupled to a burner configured to burn fuel supplied thereto at a range of pressures and/or flow rates. In at least one embodiment, the source line can be coupled to a source of fuel configured to supply the fuel at a pressure and/or flow rate higher than the range.

In at least one embodiment, the actuator can control the valve in a low output mode when the sensor detects the operating level below a threshold and a high output mode when the sensor detects the operating level above the threshold. In at least one embodiment, the actuator can run a control loop with a first gain setting when the sensor detects the operating level below a threshold and a second gain setting when the sensor detects the operating level above the threshold. In at least one embodiment, the first gain setting can be different from the second gain setting. In at least one embodiment, the actuator can run a proportional integral control loop with a first gain setting for the proportional component and a second gain setting for the integral component when the sensor detects the operating level below a threshold; and a third gain setting for the proportional component and a fourth gain setting for the integral component when the sensor detects the operating level above the threshold. In at least one embodiment, the first gain setting can be different from the third gain setting and the second gain setting can be different from the fourth gain setting.

In at least one embodiment, the actuator can control the valve in a low output mode when the sensor detects an operating level below a threshold and a high output mode when the sensor detects an operating level above a threshold. In at least one embodiment, the actuator can run a control loop with one set of gain settings, such as from a lookup table or database, when the sensor detects an operating level below a threshold, and a second (or other) set of gain settings, such as from a lookup table or database, when the sensor detects an operating level above the threshold. In at least one embodiment, a first gain setting can be different from a second (or other) gain setting. In at least one embodiment, the actuator can run a proportional integral (PI) control loop with different gain settings for the proportional and integral components, such as based on data obtained from a lookup table or database based on one or more process inputs (including but not limited to valve position, pressure, flow rate, pipe size, etc.), when the sensor detects the operating level above or below a threshold. In at least one embodiment, two or more gain settings in a lookup table or database can be different from each other.

In at least one embodiment, the sensor can be a switch, such as a pressure, flow, or temperature switch. In at least one embodiment, the sensor can be an analog or digital pressure, flow, or temperature sensor.

Other and further embodiments utilizing one or more aspects of the disclosure can be devised without departing from the spirit of Applicants' disclosure. For example, the devices, systems and methods can be implemented for numerous different types and sizes in numerous different industries. Further, the various methods and embodiments of the devices, systems and methods can be included in combination with each other to produce variations of the disclosed methods and embodiments. Discussion of singular elements can include plural elements and vice versa. The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the inventions has been described. Obvious modifications and alterations to the described embodiments are available to those of ordinary skill in the art having the benefits of the present disclosure. The disclosed and undisclosed embodiments are not intended to limit or restrict the scope or applicability of the inventions conceived of by the Applicants, but rather, in conformity with the patent laws, Applicants intend to fully protect all such modifications and improvements that come within the scope or range of equivalents of the following claims.

1. A fuel regulator, comprising:
a control valve plumbed between a source line and a feed line, wherein the feed line is coupled to a burner configured to burn fuel supplied thereto at a range of pressures and the source line is coupled to a source of fuel configured to supply the fuel at a pressure higher than the range of pressures;
a sensor configured to detect an operating level of the burner; and
an actuator configured to control the valve according to the sensor and thereby control the burner.

2. The fuel regulator of claim 1, wherein the actuator controls the valve in a low output mode when the sensor detects the operating level below a threshold and a high output mode when the sensor detects the operating level above the threshold.

3. The fuel regulator of claim 1, wherein the actuator runs a control loop with a first gain setting when the sensor detects the operating level below a threshold and a second gain setting when the sensor detects the operating level above the threshold, and wherein the first gain setting is different from the second gain setting.

4. The fuel regulator of claim 1, wherein the actuator runs a proportional integral control loop with a first gain setting for the proportional component and a second gain setting for the integral component when the sensor detects the operating level below a threshold and a third gain setting for the proportional component and a fourth gain setting for the integral component when the sensor detects the operating level above the threshold, and wherein the first gain setting is different from the third gain setting and the second gain setting is different from the fourth gain setting.

5. The fuel regulator of claim 3, wherein at least one of the first and second gain settings comprises a set of gain settings stored in a lookup table or database accessible by the actuator.

6. The fuel regulator of claim 4, wherein one or more of the gain settings is obtained from a lookup table or database accessible by the actuator and containing data based on one or more process inputs.

7. The fuel regulator of claim 1, wherein the sensor comprises at least one of a switch, a pressure switch, a pressure sensor, and a combination thereof.

8. A fuel regulator, comprising:
a control valve plumbed between a source line and a feed line, wherein the feed line is coupled to a burner configured to burn fuel supplied thereto at a range of flow rates and the source line is coupled to a source of fuel configured to supply the fuel at a flow rate higher than the range of flow rates;
a sensor configured to detect an operating level of the burner; and
an actuator configured to control the valve according to the sensor and thereby control the burner.

9. The fuel regulator of claim 8, wherein the actuator controls the valve in a low output mode when the sensor detects the operating level below a threshold and a high output mode when the sensor detects the operating level above the threshold.

10. The fuel regulator of claim 8, wherein the actuator runs a control loop with a first gain setting when the sensor detects the operating level below a threshold and a second gain setting when the sensor detects the operating level above the threshold, and wherein the first gain setting is different from the second gain setting.

11. The fuel regulator of claim 8, wherein the actuator runs a proportional integral control loop with a first gain setting for the proportional component and a second gain setting for the integral component when the sensor detects the operating level below a threshold and a third gain setting for the proportional component and a fourth gain setting for the integral component when the sensor detects the operating level above the threshold, and wherein the first gain setting is different from the third gain setting and the second gain setting is different from the fourth gain setting.

12. The fuel regulator of claim 10, wherein at least one of the first and second gain settings comprises a set of gain settings stored in a lookup table or database accessible by the actuator.

13. The fuel regulator of claim 11, wherein one or more of the gain settings is obtained from a lookup table or database accessible by the actuator and containing data based on one or more process inputs.

14. The fuel regulator of claim 8, wherein the sensor comprises at least one of a switch, a pressure switch, a pressure sensor, and a combination thereof.

15. A regulator, comprising:
a control valve plumbed between a source line and a feed line, wherein the feed line is configured to supply material to a consumer of the material and the source line is coupled to a source of the material;
a sensor configured to detect an operational parameter of the consumer; and
an actuator configured to control the valve according to the sensor and thereby control the consumer.

16. The regulator of claim 15, wherein the actuator controls the valve in a low output mode when the sensor detects the operational parameter below a threshold and a high output mode when the sensor detects the operational parameter above the threshold.

17. The regulator of claim 15, wherein the actuator runs a control loop with a first set of gain settings when the sensor detects the operational parameter below a threshold and a second set of gain settings when the sensor detects the operational parameter above the threshold, and wherein the first set of gain settings is different from the second set of gain settings.

18. The regulator of claim 15, wherein the actuator runs a proportional integral control loop with a first gain setting for the proportional component and a second gain setting for the integral component when the sensor detects the operational parameter below a threshold and a third gain setting for the proportional component and a fourth gain setting for the integral component when the sensor detects the operational parameter above the threshold, wherein the first gain setting is different from the third gain setting and the second gain setting is different from the fourth gain setting, and wherein one or more of the gain settings is obtained from a lookup table or database accessible by the actuator and containing data based on one or more process inputs.

19. The regulator of claim 15, wherein the sensor is a switch.

20. The regulator of claim 15, wherein the sensor is a pressure sensor.
